(19) United States
(12) Patent Application Publication
(10) Pub. No.: US 2016/0007818 A1
(43) Pub. Date: Jan. 14, 2016

(54) CLEANING DEVICE FOR CLEANING A MOBILE DEVICE

(71) Applicant: Weber Trade & Marketing GmbH, Filderstadt (DE)

(72) Inventor: Axel Weber, Kirchentellinsfurt (DE)

(21) Appl. No.: 14/797,189

(22) Filed: Jul. 13, 2015

(30) Foreign Application Priority Data
Jul. 14, 2014 (DE) 20 2014 005 668.4

(51) Int. Cl. A47L 13/16; B08B 1/00

(52) U.S. Cl. CPC A47L 13/16; B08B 1/006

(57) ABSTRACT

A cleaning device for cleaning a mobile device includes a supporting layer, an adhesive layer disposed on the supporting layer, and a cleaning layer disposed on the supporting layer. The adhesive layer is configured to releasably adhere to a surface on a rear side of the mobile device. The cleaning layer is configured to clean a display face of the mobile device.

### CROSS-REFERENCE TO PRIOR APPLICATION

Priority is claimed to German Patent Application No. DE 20 2014 005 668.4, filed on Jul. 14, 2014, the entire disclosure of which is hereby incorporated by reference herein.

### FIELD

The invention relates to a cleaning device for cleaning a mobile device, in particular a smartphone or a tablet computer.

### BACKGROUND

Cleaning cloths, the cleaning effect of which is satisfactory, are known for cleaning in particular the display face of a mobile device. However, handling these cleaning cloths is inconvenient.

### SUMMARY

A cleaning device for cleaning a mobile device includes a supporting layer, an adhesive layer disposed on the supporting layer, and a cleaning layer disposed on the supporting layer. The adhesive layer is configured to releasably adhere to a surface on a rear side of the mobile device. The cleaning layer is configured to clean a display face of the mobile device.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a bottom view of an embodiment of a cleaning device for cleaning a mobile device;

FIG. 2 is a side view of the cleaning device according to FIG. 1;

FIG. 3 is a plan view of the cleaning device according to FIG. 1;

FIG. 4 is a side view of an embodiment of a system comprising a mobile device and comprising a cleaning device adhesively fastened to the mobile device according to FIGS. 1 to 3;

FIG. 5 is a bottom view of the system according to FIG. 4, in which the rear side of the mobile device and an outside of the cleaning device are shown; and

FIG. 6 is a plan view of the system according to FIG. 4, in which a display face of the mobile device and the outside of the cleaning device are shown and in which the cleaning device is released from the mobile device for the purpose of cleaning the display face.

### DETAILED DESCRIPTION

In an embodiment, the present invention provides a cleaning device comprising a supporting layer, an adhesive layer disposed on the supporting layer, and a cleaning layer disposed on the supporting layer, the adhesive layer being configured releasably adhere to a surface of the mobile device, in particular to its rear side, and the cleaning layer being configured for cleaning a surface of the mobile device, in particular a display face of the mobile device.

The cleaning device according to the invention can easily be fastened to a mobile device and released therefrom. This simplifies the handling of the cleaning layer, which can easily be carried along with the mobile device. The supporting layer on which the adhesive layer and the cleaning layer are disposed has the advantage that said supporting layer fulfils a protective function for the adhesive layer and for the cleaning layer and also, moreover, serves as a protective layer for the side of the mobile device covered by the cleaning device.

The area of the supporting layer is advantageously smaller than the rear side of the mobile device. An unintentional release of the cleaning device from the mobile device can thus be avoided.

The supporting layer may, for example, be circular. However, it is preferred if the supporting layer is rectangular, so that the face of the supporting layer that is visible when fastening the cleaning device to the mobile device is adapted to the shape of the mobile device and so a particularly large supporting face can be provided for a cleaning layer that has as large an area as possible.

A particularly simple structure is produced when the cleaning layer and the adhesive layer are both arranged in a plane that runs parallel to a plane in which the supporting layer extends.

It is particularly advantageous if the cleaning layer and the adhesive layer taken together have a total combined area that is the same as that of the supporting layer. The size of the cleaning layer can thus be maximised and the remaining area can be utilised for the adhesive layer.

In a particularly advantageous embodiment it is provided that the cleaning layer is arranged between two adhesive layer portions that are spaced apart from one another. This makes it possible to fasten the cleaning device at two points on the mobile device that are spaced apart from one another and to arrange the cleaning layer between these fastening points.

It is particularly preferred if the adhesive layer portions are arranged on the narrow sides of a rectangular supporting layer and are, in particular, strip-shaped. The area available for the cleaning layer can thus be optimised.

It is furthermore preferred if the cleaning layer has a length measured between the adhesive layer portions that is larger than a width of the surface to be cleaned of the mobile device. When utilising the cleaning layer and when the cleaning layer is passed over the display face of the mobile device, a complete covering of the cleaning layer with the display face can thus be ensured.

In principle, it is conceivable to glue or sew the adhesive layer and the supporting layer and/or the cleaning layer and the supporting layer to one another. However, it is particularly preferred if the connection between said layers is formed by a welded connection.

A preferred material for the cleaning layer is microfibre material, which is particularly well suited for cleaning glass or glass-like materials of a mobile device.

The adhesive layer is advantageously produced from “gecko tape”. This product is a silicone film having microscopically small adhesive elements, which produce a high adhesive force, in particular on smooth surfaces. A material of this type is offered, for example, by the company Gottlieb Binder GmbH & Co. KG, Holzgerlingen, Germany.

The supporting layer is, in particular, a flexible material, preferably a plastics material and/or leather material. These materials have the advantage that they fulfil not only a supporting function for the adhesive layer and for the cleaning layer, but also, moreover, a protective function to protect the side of the mobile device covered by the cleaning device. Furthermore, said materials are haptically pleasant.

It is furthermore preferred if the supporting layer is produced from an anti-slip material (for example a plastics material and/or leather material) or that the supporting layer is provided on its outside with an anti-slip additional layer, for example by means of a rubber coating. This makes it possible to grip the mobile device particularly easily and securely when the cleaning device adheres to said mobile device by means of the adhesive layer.

The invention furthermore relates to a system, which comprises a mobile device and a cleaning device described above.

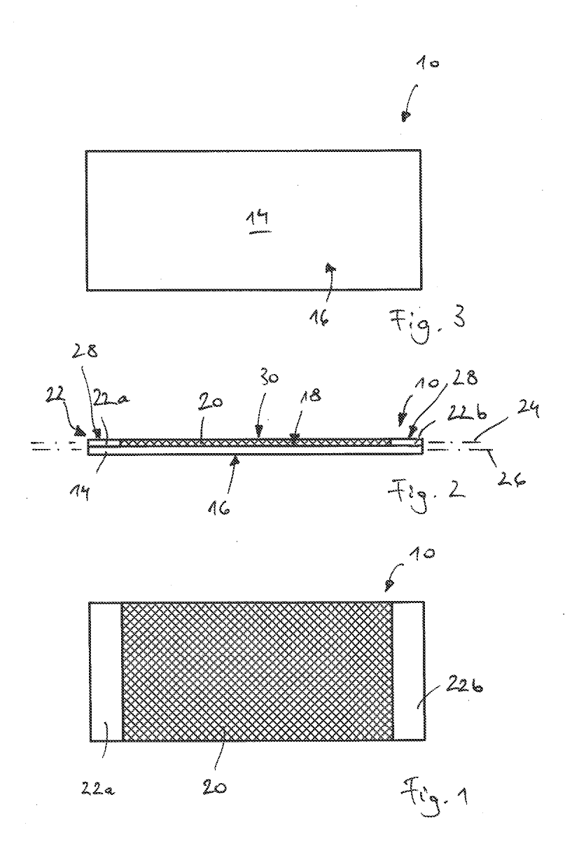

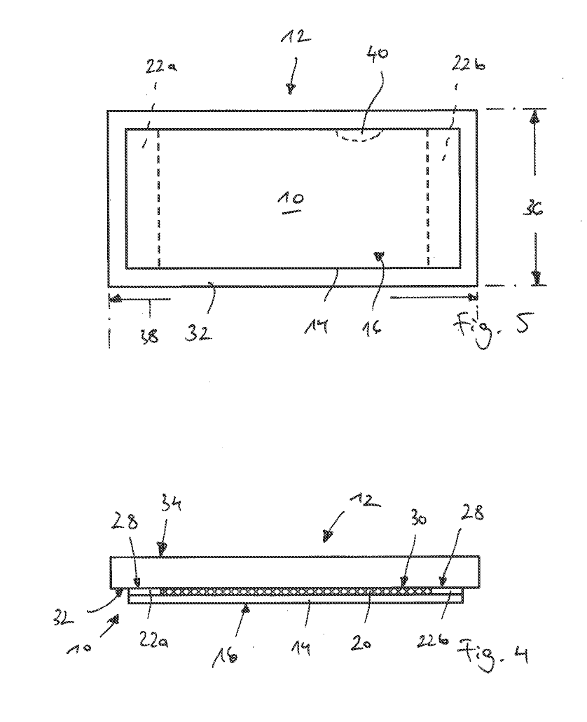

A cleaning device is denoted overall in the drawings by the reference numeral 10. In FIGS. 1 to 3, the cleaning device 10 is shown in the state in which it is released from a mobile device 12 (cf. FIGS. 4 to 6).

The cleaning device 10 comprises a rectangular supporting layer 14 having an outside 16. A cleaning layer 20 and an adhesive layer 22 having adhesive layer portions 22a, 22b are arranged, in particular fastened by welded connections, on the inside 18 of the supporting layer 14 which is remote from the outside 16.

The adhesive layer 22 and the cleaning layer 20 extend in a plane 24 which runs parallel to a plane 26 in which the supporting layer 14 extends.

The adhesive layer portions 22a, 22b are strip-shaped and preferably arranged on the narrow sides of the supporting layer 14. The area of the supporting layer 14 that is not utilised by the adhesive layer portions 22a, 22b is preferably completely filled by the rectangular cleaning layer 20.

The adhesive layer portions 22a, 22b have adhesive faces 28 remote from the supporting layer 14. It is preferred for a cleaning face 30 of the cleaning layer 20 that is remote from the supporting layer 14 to be arranged approximately at the same height as the adhesive faces 28.

A layer thickness of the supporting layer is, for example, between approximately 0.5 mm and approximately 2 mm. A layer thickness of the adhesive layer 22 is, for example, between about 0.2 mm and about 0.5 mm.

The dimensions of the cleaning device 10 are adapted to the dimensions of a mobile device 12. The mobile device 12 has a rear side 32 and a display face 34 remote from the rear side 32. The rear side 32 and the display face 34 are in each case rectangular and have a width 36 and a length 38.

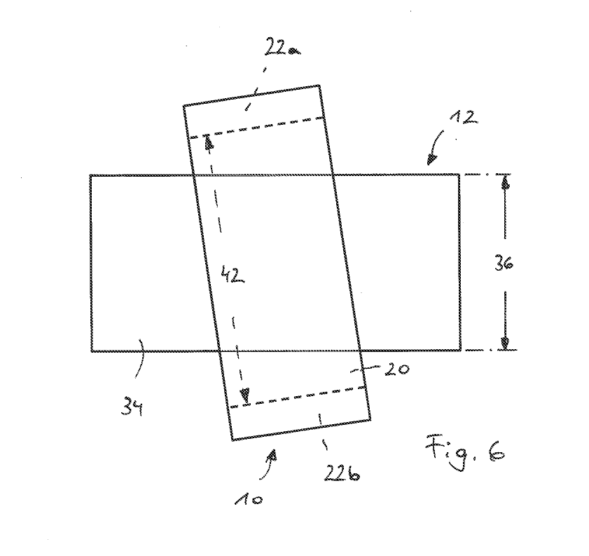

The rectangular shape of the cleaning device 10 is adapted to the mobile device 12 or its width 36 and length 38 in such a way that the cleaning device 10 is the same size or is slightly smaller (cf. FIGS. 4 and 5).

When fastening the cleaning device 10 to the mobile device 12, the adhesive faces 28 adhere to the rear side 32 of the mobile device 12. In this state it is preferred if the rear side 32 of the mobile device 12 projects over the cleaning device 10 laterally in all directions.

When the cleaning device 10 is fastened to the mobile device 12, the cleaning layer 20 and the adhesive layer 22 are covered by the supporting layer 14, and therefore these layers are protected from mechanical influences and also from dirt.

To release the cleaning device 10 from the mobile device 12, it is possible to introduce a fingertip under the cleaning face 30 of the cleaning layer 20 (indicated by the reference numeral 40 in FIG. 5) in order to release the adhesive faces 28 of the adhesive layer 22 from the rear side 32 of the mobile device 12.

To clean the mobile device 12, the cleaning face 30 of the cleaning layer 20 and the display face 34 of the mobile device 12 are brought into contact with one another. It is preferred here for a length 42 measured between the adhesive layer portions to be greater than the width 36 of the mobile device 12, so that the cleaning device, when rotated by approximately 90° (cf. FIG. 6) compared with when it is fastened to the mobile device 12, can clean the mobile device 12 along its entire length by passing the cleaning layer 20 over, without the adhesive layer portions 22a, 22b coming into contact with the display face 34.

On completion of the cleaning process, the cleaning device 10 can be fastened to the mobile device 12 again; cf. FIGS. 4 and 5.

The cleaning device 10 can be easily cleaned, for example under running water. Dirt particles collecting on the adhesive faces 28 over time can thereby be removed.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A cleaning device for cleaning a mobile device, the cleaning device comprising:
a supporting layer;
an adhesive layer disposed on the supporting layer; and
a cleaning layer disposed on the supporting layer,
wherein the adhesive layer is configured to releasably adhere to a surface on a rear side of the mobile device, and
wherein the cleaning layer is configured to clean a display face of the mobile device.

2. The cleaning device of claim 1, wherein the area of the supporting layer is smaller than the rear side of the mobile device.

3. The cleaning device of claim 1, wherein the supporting layer is rectangular.

4. The cleaning device of claim 1, wherein the cleaning layer and the adhesive layer are both arranged in a plane that runs parallel to a plane in which the supporting layer extends.

5. The cleaning device of claim 1, wherein the cleaning layer and the adhesive layer taken together have a total combined area that is the same as that of the supporting layer.

6. The cleaning device of claim 1, wherein the cleaning layer is arranged between two adhesive layer portions of the adhesive layer that are spaced apart from one another.

7. The cleaning device of claim 6, wherein the supporting layer is rectangular and the adhesive layer portions are arranged on the narrow sides of the supporting layer.

8. The cleaning device of claim 7, wherein the adhesive layer portions are strip-shaped.

9. The cleaning device of claim 6, wherein the cleaning layer has a length measured between the adhesive layer portions that is larger than a width of the display face of the mobile device.

10. The cleaning device of claim 1, wherein at least one of the adhesive layer and the supporting layer, or the cleaning layer and the supporting layer, are connected to one another by a welded connection.

11. The cleaning device of claim 1, wherein the cleaning layer is produced from a microfibre material.

12. The cleaning device of claim 1, wherein the adhesive layer is produced from gecko tape.

13. The cleaning device of claim 1, wherein the supporting layer is produced from at least one of a plastics material or a leather material.

14. The cleaning device of claim 1, wherein the supporting layer is produced from an anti-slip material.

15. The cleaning device of claim 1, wherein the supporting layer is provided on its outside with an anti-slip additional layer.

16. A system comprising a mobile device and the cleaning device of claim 1.
